(19) United States
(12) Patent Application Publication
(10) Pub. No.: US 2021/0127894 A1
(43) Pub. Date: May 6, 2021

(54) Cooking Pot Insulator Assembly

(71) Applicant: Mary Hepler, Jonestown, PA (US)

(72) Inventor: Mary Hepler, Jonestown, PA (US)

(21) Appl. No.: 16/675,706

(22) Filed: Nov. 6, 2019

(51) Int. Cl. A47J 36/36; A47J 36/06

(52) U.S. Cl. CPC A47J 36/36; A47J 36/06

(57) ABSTRACT

A cooking pot insulator assembly includes a pad that is positionable on a lid of a cooking pot. The pad has a rounded perimeter such that the pad has a circular shape for conforming to the shape of the lid. The pad has a handle opening extending therethrough for accommodating a handle of the lid when the pad is positioned on the lid. The pad is comprised of a thermally insulating material to reduce heat loss through the lid. A strap is coupled to and extends away from the pad. A fastener is coupled to the pad and the strap releasably engaging the fastener such that the strap forms a closed loop for support a cooking utensil when the pad is positioned on the lid.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

The disclosure relates to insulator devices and more particularly pertains to a new insulator device for insulating a lid of a cooking pot.

### (2) Description of Related Art Including Information Disclosed Under 37 CFR 1.97 and 1.98

The prior art relates to insulator devices. The prior art includes an insulated pad that can be laid on top of a lid of a cooking pot for thermally insulating the lid. The insulated pad in the prior art covers the handle of the lid when the insulated pad is positioned on the lid. The prior art also includes an insulated wrap that can be wrapped around a cooking pot. The insulated wrap includes handle openings for accommodating handles on the cooking pot when the insulated wrap is wrapped around the cooking pot.

### BRIEF SUMMARY OF THE INVENTION

An embodiment of the disclosure meets the needs presented above by generally comprising a pad that is positionable on a lid of a cooking pot. The pad has a rounded perimeter such that the pad has a circular shape for conforming to the shape of the lid. The pad has a handle opening extending therethrough for accommodating a handle of the lid when the pad is positioned on the lid. The pad is comprised of a thermally insulating material to reduce heat loss through the lid. A strap is coupled to and extends away from the pad. A fastener is coupled to the pad and the strap releasably engaging the fastener such that the strap forms a closed loop for support a cooking utensil when the pad is positioned on the lid.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a top perspective in-use view of a cooking pot insulator assembly according to an embodiment of the disclosure.

FIG. 2 is a top view of an embodiment of the disclosure.

FIG. 3 is a bottom view of an embodiment of the disclosure.

FIG. 4 is a top view of an embodiment of the disclosure showing a strap being coupled to a fastener.

FIG. 5 is a top view of an embodiment of the disclosure showing a pad without a panel covering a handle opening.

FIG. 6 is a bottom view of an embodiment of the disclosure showing a pad without a panel covering a handle opening.

### DETAILED DESCRIPTION OF THE INVENTION

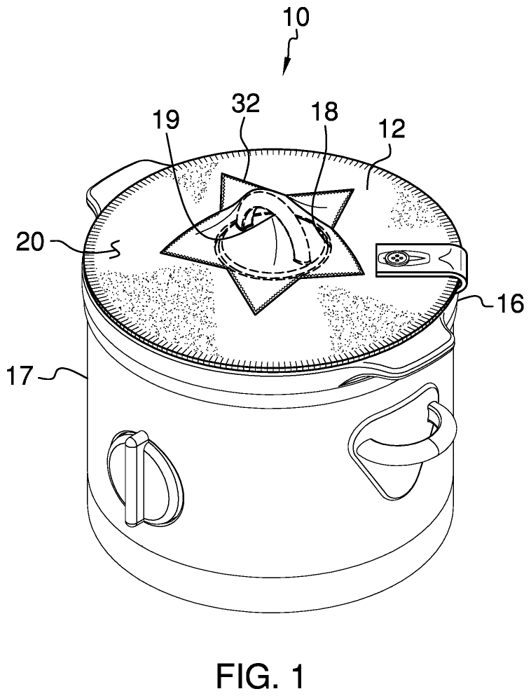

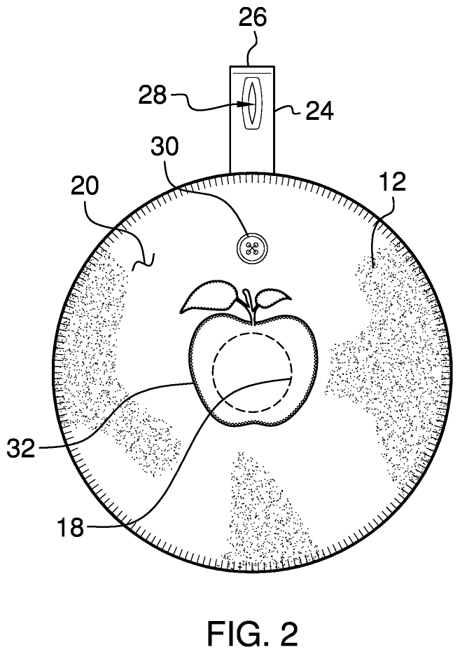

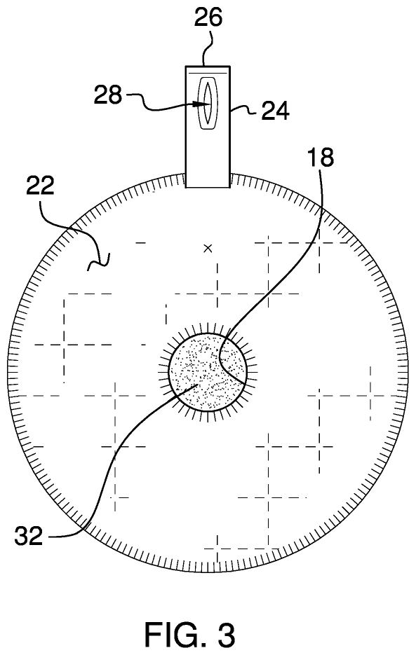

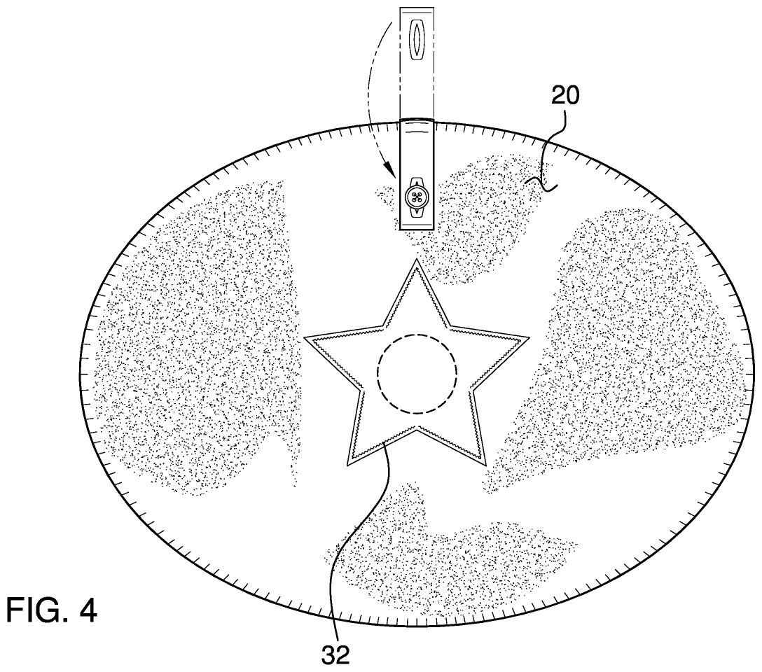

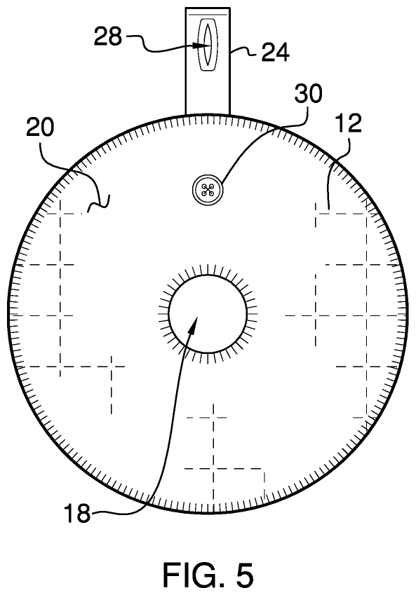

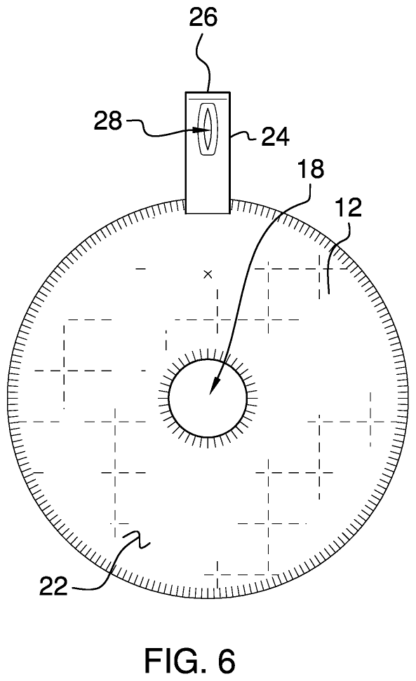

With reference now to the drawings, and in particular to FIGS. 1 through 6 thereof, a new insulator device embodying the principles and concepts of an embodiment of the disclosure and generally designated by the reference numeral 10 will be described.

As best illustrated in FIGS. 1 through 6, the cooking pot insulator assembly 10 generally comprises a pad 12 that is positionable on a lid 16 of a cooking pot 17. The cooking pot 17 may be an electric crock pot, a dutch oven, a soup pan or any other type of pot used for cooking food. The lid 16 may have a circular shape or an ovoid shape. The pad 12 has a rounded perimeter such that the pad 12 has a circular shape, or an ovoid shape, for conforming to the shape of the lid 16. Additionally, the pad 12 may be manufactured with a variety of diameters for accommodating a variety of lid 16 sizes.

The pad 12 has a handle opening 18 extending therethrough for accommodating a handle 19 of the lid 16 when the pad 12 is positioned on the lid 16. Additionally, the pad 12 is comprised of a thermally insulating material. In this way the pad 12 can reduce heat loss through the lid 16. The pad 12 has a top surface 20 and a bottom surface 22, and the handle opening 18 extends through the top surface 20 and the bottom surface 22. The handle opening 18 is centrally positioned on the pad 12 and the bottom surface 22 of the pad 12 lies on the lid 16 when the pad 12 is positioned on the lid 16.

A strap 24 is coupled to and extends away from the pad 12. The strap 24 is positioned on the top surface 20 of the pad 12 and the strap 24 has a distal end 26 with respect to the top surface 20. The strap 24 has a slot 28 extending therethrough and the slot 28 is positioned adjacent to the distal end 26. Moreover, the strap 24 is attached to the pad 12 at a point that is located adjacent to the perimeter of the pad 12. The strap 24 may have a length ranging between approximately 3.0 inches and 6.0 inches.

A fastener 30 is provided and the fastener 30 is coupled to the pad 12. The strap 24 releasably engages the fastener 30 such that the strap 24 forms a closed loop. Thus, the strap 24 can support a cooking utensil, such as a spoon or the like, when the pad 12 is positioned on the lid 16. The fastener 30 is positioned on the top surface 20 of the pad 12 and the fastener 30 engages the slot 28 in the strap 24 when the strap 24 is coupled to the fastener 30. The fastener 30 may comprise a button, a hook or other type of releasable fastener.

As is most clearly shown in FIGS. 1 through 4, a panel 32 is coupled to the top surface 20 of the pad 12. The panel 32 covers the handle opening 18 in the pad 12. Additionally, the panel 32 is comprised of a resiliently stretchable material for stretching around the handle 19 of the lid 16. The top surface 20 of the pad 12 may comprise terry cloth or other similar plush material. The bottom surface 22 of the pad 12 may comprise a quilted material or other similar material. The perimeter of the pad 12 may have ornamental stitching extending therearound.

In use, the pad 12 is positioned on the lid 16 when the cooking pot 17 is used for cooking. In this way the pad 12 reduces heat loss through the lid 16 during cooking. Additionally, the handle opening 18 accommodates the handle of the lid 16 thereby facilitating the pad 12 to lie flat on the lid 16. The strap 24 is coupled to the fastener 30 for forming a closed loop. The cooking utensil can be stored in the closed loop formed by the strap 24 while the pad 12 is positioned on the lid 16. Additionally the strap 24 can be fastened to a support for storing the pad 12.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A cooking pot insulator assembly being configured to be positioned on a lid of a cooking pot for thermally insulating the lid, said assembly comprising:
a pad being positionable on a lid of a cooking pot, said pad having a rounded perimeter such that said pad has a circular shape for conforming to the shape of the lid, the pad has a handle opening extending therethrough for accommodating a handle of the lid when said pad is positioned on the lid, said pad being comprised of a thermally insulating material wherein said pad is configured to reduce heat loss through the lid;
a strap being coupled to and extending away from said pad; and
a fastener being coupled to said pad, said strap releasably engaging said fastener such that said strap forms a closed loop wherein said strap is configured to support a cooking utensil when said pad is positioned on the lid.

2. The assembly according to claim 1, wherein said pad has a top surface and a bottom surface, said handle opening extending through said top surface and said bottom surface, said handle opening being centrally positioned on said pad, said bottom surface lying on the lid when said pad is positioned on the lid.

3. The assembly according to claim 2, wherein said strap is positioned on said top surface of said pad, said strap having a distal end with respect to said top surface.

4. The assembly according to claim 2, wherein said strap has a slot extending therethrough, said slot being positioned adjacent to a distal end of said strap, said strap being attached to said pad at a point being located adjacent to said perimeter of said pad.

5. The assembly according to claim 4, wherein said fastener is positioned on said top surface of said pad, said fastener engaging said slot in said strap when said strap is coupled to said fastener.

6. A cooking pot insulator assembly being configured to be positioned on a lid of a cooking pot for thermally insulating the lid, said assembly comprising:
a pad being positionable on a lid of a cooking pot, said pad having a rounded perimeter such that said pad has a circular shape for conforming to the shape of the lid, the pad has a handle opening extending therethrough for accommodating a handle of the lid when said pad is positioned on the lid, said pad being comprised of a thermally insulating material wherein said pad is configured to reduce heat loss through the lid, said pad having a top surface and a bottom surface, said handle opening extending through said top surface and said bottom surface, said handle opening being centrally positioned on said pad, said bottom surface lying on the lid when said pad is positioned on the lid;
a strap being coupled to and extending away from said pad, said strap being positioned on said top surface of said pad, said strap having a distal end with respect to said top surface, said strap having a slot extending therethrough, said slot being positioned adjacent to said distal end, said strap being attached to said pad at a point being located adjacent to said perimeter of said pad; and
a fastener being coupled to said pad, said strap releasably engaging said fastener such that said strap forms a closed loop wherein said strap is configured to support a cooking utensil when said pad is positioned on the lid, said fastener being positioned on said top surface of said pad, said fastener engaging said slot in said strap when said strap is coupled to said fastener.

7. The assembly according to claim 6, further comprising a panel being coupled to said top surface of said pad, said panel covering said handle opening, said panel being comprised of a resiliently stretchable material wherein said panel is configured to stretch around the handle of the lid.
